(19) United States
(12) Patent Application Publication
(10) Pub. No.: US 2021/0039900 A1
(43) Pub. Date: Feb. 11, 2021

(54) SHEET PROCESSING APPARATUS AND IMAGE FORMING SYSTEM INCORPORATING THE SHEET PROCESSING APPARATUS

(71) Applicants: Takehisa SHIMAZU, Kanagawa (JP); Keisuke SUGIYAMA, Kanagawa (JP); Tomohiro FURUHASHI, Kanagawa (JP); Wataru TAKAHASHI, Tokyo (JP); Yuji SUZUKI, Kanagawa (JP); Joji AKIYAMA, Kanagawa (JP); Yosuke IIDA, Kanagawa (JP)

(72) Inventors: Takehisa SHIMAZU, Kanagawa (JP); Keisuke SUGIYAMA, Kanagawa (JP); Tomohiro FURUHASHI, Kanagawa (JP); Wataru TAKAHASHI, Tokyo (JP); Yuji SUZUKI, Kanagawa (JP); Joji AKIYAMA, Kanagawa (JP); Yosuke IIDA, Kanagawa (JP)

(73) Assignee: Ricoh Company, Ltd., Tokyo (JP)

(21) Appl. No.: 16/938,053

(22) Filed: Jul. 24, 2020

(30) Foreign Application Priority Data
Aug. 9, 2019 (JP) 2019-148124

(51) Int. Cl. B65H 3/06; B65H 29/12

(52) U.S. Cl. CPC B65H 3/0684; B65H 2801/06; B65H 29/125; B65H 3/0669

(57) ABSTRACT

A sheet processing apparatus includes a sheet conveyor, a plurality of processing tools, and a tool moving device. The sheet conveyor is configured to convey a sheet. The plurality of processing tools is disposed in a conveyance direction of the sheet and is configured to perform processing to the sheet. The tool moving device is configured to move the plurality of processing tools in an intersecting direction intersecting the conveyance direction of the sheet.

### CROSS-REFERENCE TO RELATED APPLICATION

This patent application is based on and claims priority pursuant to 35 U.S.C. § 119(a) to Japanese Patent Application No. 2019-148124, filed on Aug. 9, 2019, in the Japan Patent Office, the entire disclosure of which is hereby incorporated by reference herein.

### BACKGROUND

### Technical Field

This disclosure relates to a sheet processing apparatus and an image forming system incorporating the sheet processing apparatus.

### Background Art

Various types of sheet processing apparatuses are known to perform a cut process and a crease process to a sheet. Such a sheet processing apparatus is used to create the processing patterns of stickers, cards, or box-shaped 3D objects, from a sheet on which an image or design pattern is printed.

It is known there are various types of sheet processing apparatuses, for example, a flatbed type sheet processing apparatus and a conveyance type sheet processing apparatus. The flatbed type sheet processing apparatus fixes a sheet that is a process target object, on a flat face provided on the apparatus, and causes processing tools (i.e., a cutter tool and a creasing tool or a creasing tool) to selectively contact the sheet with pressure or separate from the sheet while moving the processing tools over the sheet in a two-dimensional area. By so doing, the processing tools move along a given trajectory on the sheet while contacting the sheet to perform a two-dimensional processing. On the other hand, the conveyance type sheet processing apparatus causes the processing tools (i.e., a cutter tool and a creasing tool or a creasing tool) to move in a direction orthogonal to the conveyance direction of the sheet while the sheet is conveyed in a given direction. Then, while moving the processing tools, the conveying type sheet processing apparatus causes the processing tools to selectively contact the sheet with pressure or separate from the sheet. By synchronizing movement of the sheet due to this conveyance with movement of the processing tools, the processing tools relatively move along a given trajectory on the sheet while contacting the sheet to perform a two-dimensional processing.

### SUMMARY

At least one aspect of this disclosure, a novel sheet processing apparatus includes a sheet conveyor, a plurality of processing tools, and a tool moving device. The sheet conveyor is configured to convey a sheet. The plurality of processing tools is disposed in a conveyance direction of the sheet and is configured to perform processing to the sheet. The tool moving device is configured to move the plurality of processing tools in an intersecting direction intersecting the conveyance direction of the sheet.

Further, at least one aspect of this disclosure, an image forming system includes an image forming apparatus configured to form an image on a sheet and eject the sheet with the image, and the above-described sheet processing apparatus configured to process the sheet with the image formed by the image forming apparatus.

### BRIEF DESCRIPTION OF THE SEVERAL VIEWS OF THE DRAWINGS

Exemplary embodiments of this disclosure will be described in detail based on the following figures, wherein:

FIG. 1 is a perspective view illustrating a sheet processing apparatus according to an embodiment of this disclosure;

FIG. 2 is a cross-sectional view illustrating the sheet processing apparatus;

FIG. 3 is a perspective view illustrating a main part of the sheet processing apparatus;

FIG. 4 is an enlarged side view illustrating a part of the main part of the sheet processing apparatus;

FIG. 5 is an enlarged plan view illustrating a part of the main part of the sheet processing apparatus;

FIG. 6 is an enlarged perspective view illustrating a part of the main part of the sheet processing apparatus;

FIG. 7 is a plan view illustrating a part of the main part of the sheet processing apparatus;

FIG. 8 is a perspective view illustrating a part of the main part of the sheet processing apparatus;

FIG. 9 is an enlarged perspective view illustrating a part of the main part of the sheet processing apparatus;

FIG. 10 is a block diagram illustrating a hardware configuration of a control system of the sheet processing apparatus;

FIG. 11 is a functional block diagram illustrating a control system of the sheet processing apparatus;

FIG. 12 is a side view illustrating an image forming system according to an embodiment of this disclosure;

FIGS. 13A and 13B are diagrams illustrating a configuration of a known sheet processing apparatus; and

FIGS. 14A and 14B are diagrams illustrating an effect of the configuration of the sheet processing apparatus according to the present embodiment in comparison with the known sheet processing apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

Overall Configuration of Sheet Processing Apparatus.

Hereinafter, descriptions are given of a sheet processing apparatus 100 according to the present embodiment, with reference to the drawings.

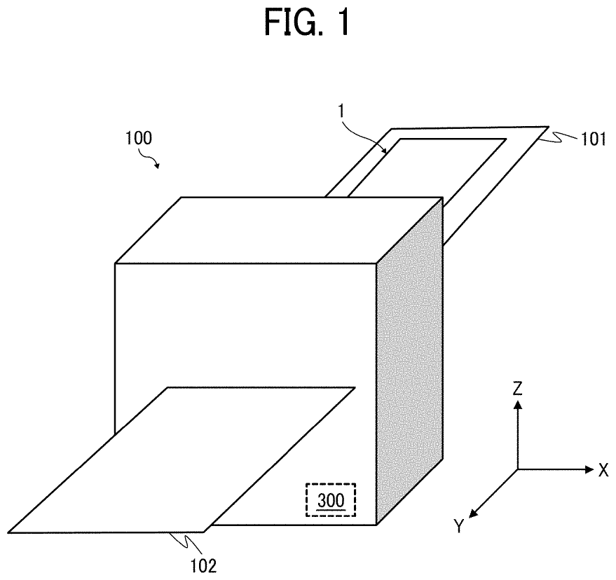

FIG. 1 is a perspective view illustrating the external appearance of a sheet processing apparatus 100 according to an embodiment of this disclosure.

As illustrated in FIG. 1, the sheet processing apparatus 100 includes a sheet receiver tray 101 and a sheet transfer tray 102. The sheet receiver tray 101 functions as a sheet receiving port via which a sheet 1 that functions as a sheet-like processing target member (sheet member) is conveyed to the sheet processing apparatus 100. The sheet transfer tray 102 functions as a sheet transfer port of the processed sheet 1 after processing. The sheet 1 is processed while being conveyed in a direction indicated by arrow Y (Y direction) in FIG. 1. Note that, as illustrated in FIG. 1, the sheet processing apparatus 100 further includes a control device 300 that controls the whole operations of the sheet processing apparatus 100.

Here, coordinate systems used to describe the present embodiment are defined. A Y direction is a direction in which the sheet 1 before processing is conveyed to the sheet processing apparatus 100 and the sheet 1 after processing is conveyed from the sheet processing apparatus 100. An X direction is a direction that intersects and is orthogonal to the Y direction (the width direction of the sheet 1), that is, a direction that corresponds to the width direction of the sheet 1. A Z direction is a direction that intersects the Y direction and the X direction and corresponds to the direction of height of the sheet processing apparatus 100.

Accordingly, the phrase “conveyance direction of the sheet 1” in the present embodiment corresponds to movement of the sheet 1 in the Y direction.

Note that the embodiment is explained based on an example in which the X direction, the Y direction, and the Z direction are orthogonal to each other. However, directions used to explain the configuration of the sheet processing apparatus 100 are not limited to a direction orthogonal to another direction. For example, a phrase “disposed in a direction orthogonal to the Y direction” does not strictly corresponds to a phrase “does not include a disposition other than the disposition (or alignment) in the Y direction.” In the following description for explaining the sheet processing apparatus 100, the directions having spelling variants are interpreted to be the same directions such as “an orthogonal direction” as long as the directions having spelling variants obtain the same or similar effect as the orthogonal direction. That is, in the description of the present embodiment, each of the X direction, the Y direction, and the Z direction are used for convenience but are not used for completely exclude the state of not being orthogonal to the very direction or the state of not being parallel to the very direction.

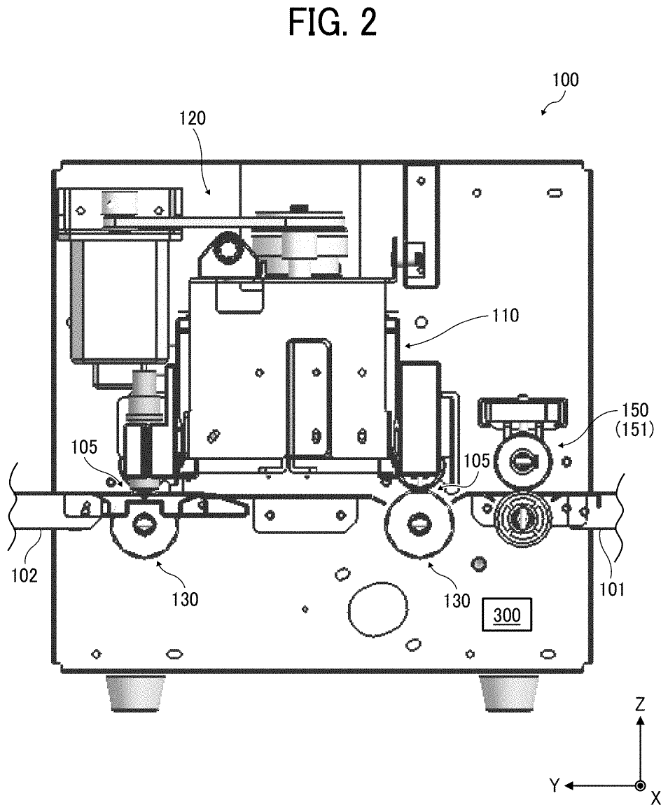

FIG. 2 is a cross-sectional view illustrating the internal configuration of the sheet processing apparatus 100. FIG. 2 is the cross-sectional view parallel to a plane Y-Z of the sheet processing apparatus 100 in FIG. 1 and the cross-sectional view from the +X direction toward the −X direction.

As illustrated in FIG. 2, the sheet processing apparatus 100 includes processing tools 105, a tool holding device 110, a tool moving device 120, and a tool facing device 130. The sheet processing apparatus 100 further includes pairs of conveyance rollers 150 that function as conveyance members to reciprocally convey the sheet 1 toward the processing tools 105. The pairs of conveyance rollers 150 include a first pair of conveyance rollers 151 and a second pair of conveyance rollers 152. In FIG. 2, the first pair of conveyance rollers 151 alone is depicted from the pairs of conveyance rollers 150. The first pair of conveyance rollers 151 is disposed on the sheet receiving port side.

The processing tools 105 are held by the tool holding device 110 so that the processing tools 105 are disposed at respective positions facing the tool facing device 130 via the sheet 1.

The tool holding device 110 holds the processing tools 105 such as a cutter tool to perform a cut process to the sheet 1 and a creasing tool to perform a crease process to the sheet 1. Details of the processing tools 105 are described below. The tool holding device 110 includes a tool moving mechanism for contact and separation of the processing tools to cause the processing tools 105 to contact to or separate from the sheet 1. That is, the tool holding device 110 includes a tool contact separator.

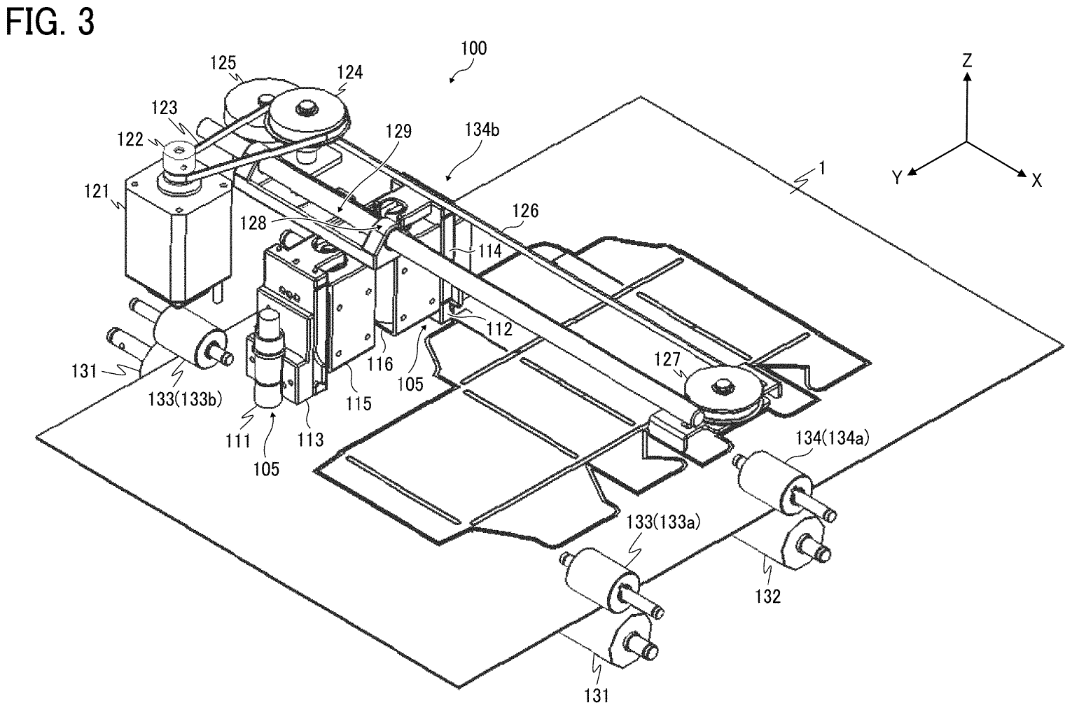

The tool moving device 120 includes a tool moving mechanism for sheet processing (the tool moving mechanism for contact and separation of the processing tools) to reciprocally move the processing tools 105 and the tool holding device 110 in the X direction when the sheet processing such as the cut process and the crease process is performed to the sheet 1. In other words, the tool moving device 120 includes a tool driving mechanism. That is, the cutter tool 111 and the creasing tool 112 move in the X direction with respect to the sheet 1 (see FIG. 3). However, the configuration of the sheet processing apparatus 100 is not limited to the above-described configuration. For example, the tool moving device 120 may include the tool moving mechanism for sheet processing that moves the processing tools 105 in the X direction and the tool holding device 110 may include the tool moving mechanism for contact and separation of the processing tools (a tool moving device moving mechanism for contact and separation of the processing tools) to cause the processing tools 105 to contact or separate from the tool moving device 120. Alternatively, a mechanism may move the processing tools 105 alone in the width direction of the sheet 1 and another mechanism may move the processing tools 105 alone to contact and separate from the sheet 1.

The tool facing device 130 includes respective opposing faces to face the processing tools 105 and are provided with respective rollers, each functioning as a rotary member that rotates. Each opposing face corresponds to a position at which the processing tools 105 contact the sheet 1 when the processing tools 105 move in the X direction in the sheet processing. In other words, the tool facing device 130 is provided to support the sheet 1 at a given position to prevent deviation of the sheet 1, so that, when the processing tools 105 contact the sheet 1 to perform sheet processing to the sheet 1, the tool facing device 130 prevents the sheet 1 that has received pressing force from the processing tools 105, from deviating to the Z direction (to be more specific, the −Z direction). As illustrated in FIG. 2, the tool opposing face of the tool facing device 130 is arranged to correspond to the same position as the processing tool 105 in the Y direction. In other words, the tool opposing face of the tool facing device 130 is disposed below the processing tool 105 in the vertical direction (the Z direction). Further, in other words, the processing tool 105 is disposed above the opposing face in the vertical direction (the Z direction) and is held not to move (that is, held to be immovable) in the Y direction.

The sheet processing apparatus 100 causes the processing tools 105 to perform the sheet processing while the sheet 1 is conveyed in the Y direction. In the sheet processing, the processing tools 105 move not in the Y direction to the tool facing device 130 but in the X direction alone to the tool facing device 130. When the sheet processing is performed to the sheet 1, while the tool holding device 110 moves to the sheet 1 in the Y direction, the processing tools 105 moves in the X direction in synchrony with movement of the tool holding device 110, so as to selectively contact to or separate from the sheet 1. With the above-described operation, the processing tools 105 (that is, the creasing tool 112 and the cutter tool 111) moves relative to the sheet 1 while drawing a trajectory including given plane free curves on the sheet 1, so as to selectively contact to or separate from the sheet 1. By so doing, the sheet processing apparatus 100 performs sheet processing to the sheet 1. That is, the sheet processing apparatus 100 performs sheet processing while drawing a given trajectory in the two-dimensional area of the sheet 1.

Configuration of Main Part of the Sheet Processing Apparatus 100.

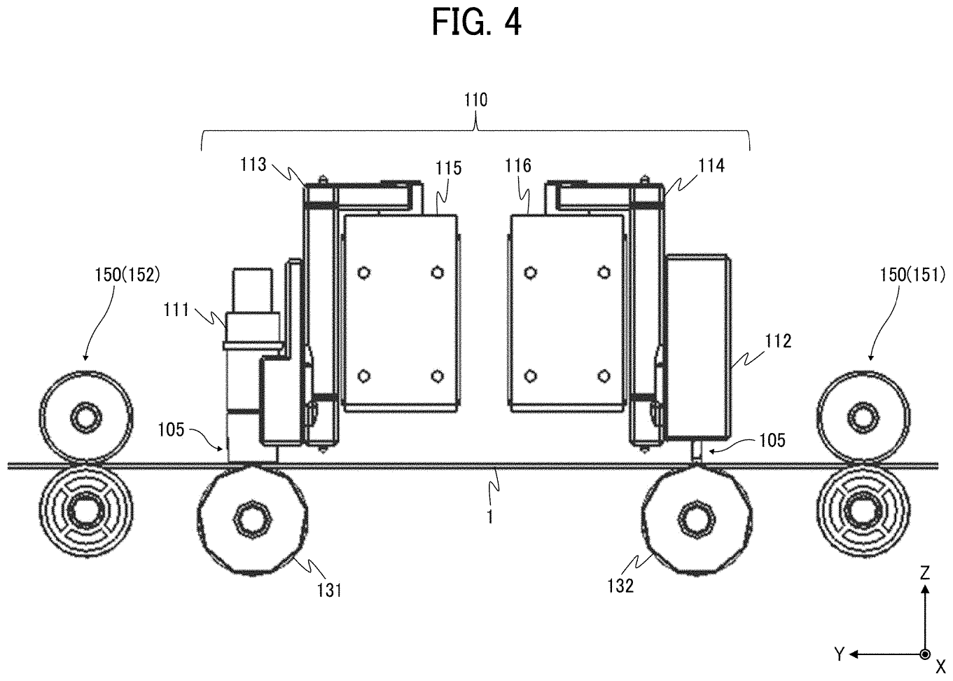

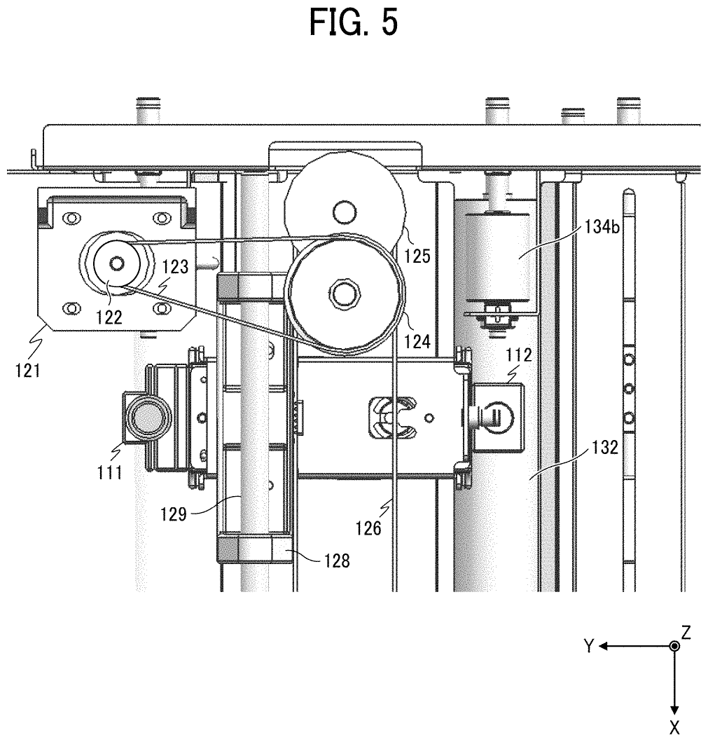

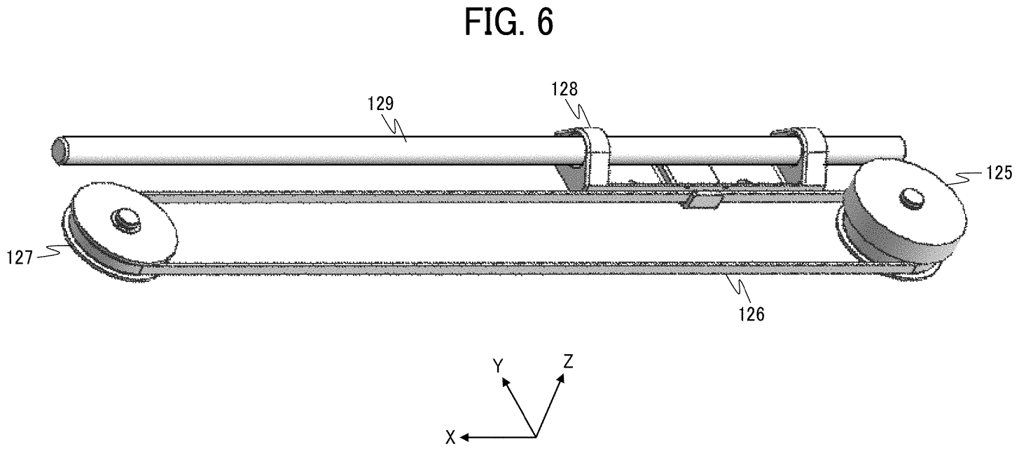

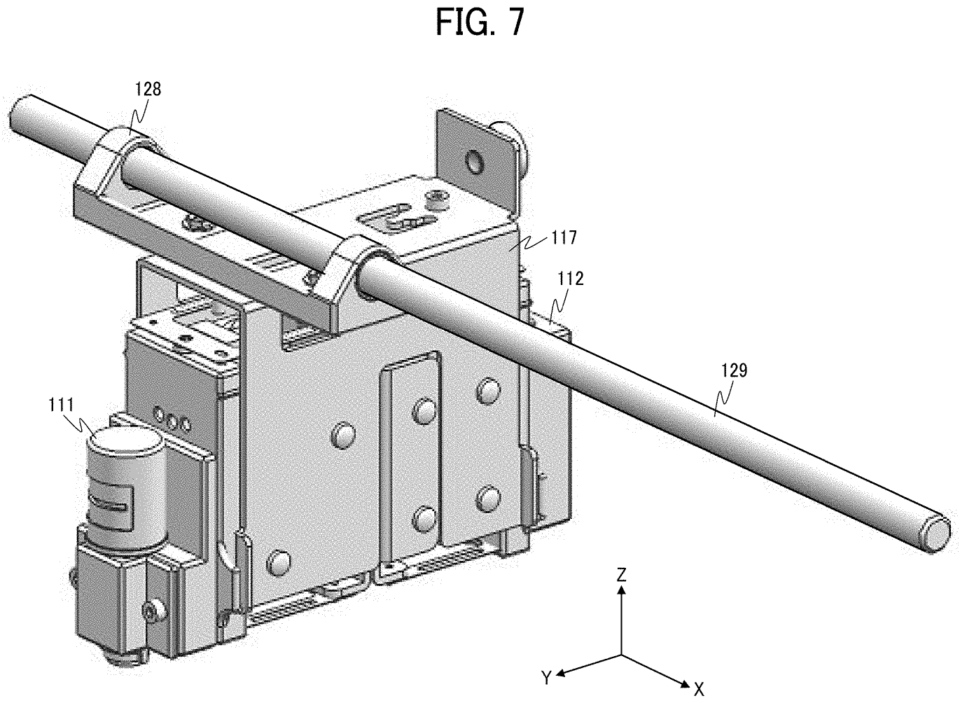

FIG. 3 is a perspective view illustrating the main part of the internal configuration of the sheet processing apparatus 100. FIG. 4 is an enlarged side view illustrating the tool holding device 110 provided in the internal configuration of the sheet processing apparatus 100. FIG. 5 is an enlarged plan view illustrating a drive source of the tool moving device 120 of the sheet processing apparatus 100. FIG. 6 is an enlarged perspective view illustrating a movable holding mechanism of the tool moving device 120 of the sheet processing apparatus 100. FIG. 7 is an enlarged perspective view a part of the tool holding device 110 and the tool moving device 120 of the sheet processing apparatus 100.

Configuration of Tool Holding Device 110.

First, a description is given of the configuration of the tool holding device 110 with reference to FIG. 4.

The tool holding device 110 includes a cutter tool 111, a creasing tool 112, a first tool holder 113, a second tool holder 114, a first contact separation actuator 115, and a second contact separation actuator 116. The cutter tool 111 and the creasing tool 112 are included in the processing tools 105.

The cutter tool 111 that functions as a first processing tool is a cutter that contacts the sheet 1 with pressure to perform the cut process to the sheet 1. The creasing tool 112 that functions as a second processing tool is a creaser that presses the sheet 1 to perform the crease process to the sheet 1, in other words, to make a crease line or lines in the surface of the sheet 1. The cutter tool 111 is retained above a first facing roller 131 in the vertical direction. The cutter tool 111 that functions as a tool facing body is disposed facing the first facing roller 131. The creasing tool 112 is retained above a second facing roller 132 in the vertical direction. The creasing tool 112 that functions as a tool facing body is disposed facing the second facing roller 132.

The first tool holder 113 couples and retains the first contact separation actuator 115 and the cutter tool 111. The second tool holder 114 couples and retains the second contact separation actuator 116 and the creasing tool 112.

The first contact separation actuator 115 and the second contact separation actuator 116 are coupled with each other by a tool retaining member 117 and a tool moving member 128. Details of the tool retaining member 117 and the tool moving member 128 are described below. The tool moving member 128 temporarily retains the cutter tool 111 and the creasing tool 112 via the tool retaining member 117. Therefore, the tool holding device 110 integrally holds the cutter tool 111 and the creasing tool 112, which are the two processing tools 105, so as to be movable together in the X direction.

The first contact separation actuator 115 and the second contact separation actuator 116 are solenoids. By supplying the power to the first contact separation actuator 115 and the second contact separation actuator 116, the cutter tool 111 and the creasing tool 112 press the sheet 1. This pressing state of the cutter tool 111 and the creasing tool 112 to the sheet 1 changes depending on the energization state of the first contact separation actuator 115 and the second contact separation actuator 116. In other words, the first contact separation actuator 115 and the second contact separation actuator 116 retain the pressing state of the cutter tool 111 and the creasing tool 112 with respect to the first facing roller 131 and the second facing roller 132. The control of the operations of the first contact separation actuator 115 and the second contact separation actuator 116 depends on the control program executed in the control device 300 described below. By performing the control, the control device 300 causes the cutter tool 111 and the creasing tool 112 to perform the contact and separation operations to selectively contact or separate from the sheet 1. This contact and separation control controls the processing operation to the sheet 1. Accordingly, the first contact separation actuator 115 and the second contact separation actuator 116 are included in the tool contact separator to contact and separate the processing tools 105 (i.e., the cutter tool 111 and the creasing tool 112) with respect to the sheet 1.

As illustrated in FIG. 4, a first pair of conveyance rollers 151 that functions as a conveyance body is disposed upstream from the tool holding device 110 in the Y direction (i.e., the conveyance direction of the sheet 1). In addition, a second pair of conveyance rollers 152 that functions as a conveyance body is disposed downstream from the tool holding device 110 in the Y direction (i.e., the conveyance direction of the sheet 1). The sheet 1 is conveyed in the Y direction by the pairs of conveyance rollers 150 (including the first pair of conveyance rollers 151 and the second pair of conveyance rollers 152). After having been conveyed from the upstream side in the Y direction to the sheet processing apparatus 100, the sheet 1 is held by the first pair of conveyance rollers 151. Due to rotation of the first pair of conveyance rollers 151, the sheet 1 is conveyed under the tool holding device 110. Then, after the sheet processing is performed to the sheet 1, the sheet 1 is held by the second pair of conveyance rollers 152 to be conveyed out from the sheet processing apparatus 100.

Configuration of Tool Moving Device 120.

Next, a description is given of the configuration of the tool moving device 120, with reference to FIGS. 3, 5, and 6.

The tool moving device 120 includes an X-axis drive motor 121, an X-axis output timing pulley 122, a first X-axis timing belt 123, an X-axis reduction timing pulley 124, a first tool moving pulley 125, a second X-axis timing belt 126, a second tool moving pulley 127, the tool moving member 128, and a tool moving guide shaft 129.

The X-axis drive motor 121 is a single drive source that is rotatable in both the forward direction and the reverse direction to move the tool holding device 110 that retains the cutter tool 111 and the creasing tool 112, in the intersecting direction (the X direction) that is a direction intersecting the conveyance direction of the sheet 1 (the Y direction). The rotary shaft of the X-axis drive motor 121 is coupled with the X-axis reduction timing pulley 124 from the X-axis output timing pulley 122 via the first X-axis timing belt 123.

The X-axis reduction timing pulley 124 is in contact with the first tool moving pulley 125 via a gear portion that is molded as a single component with the X-axis reduction timing pulley 124. Accordingly, as the X-axis drive motor 121 drives to rotate the X-axis reduction timing pulley 124, the first tool moving pulley 125 rotates via the gear portion.

As illustrated in FIGS. 5 and 6, the first tool moving pulley 125 and the second tool moving pulley 127 as a pair together are coupled by the second X-axis timing belt 126. Accordingly, the second X-axis timing belt 126 that is wound around the first tool moving pulley 125 and the second tool moving pulley 127 rotates along with rotation of the first tool moving pulley 125.

The tool moving member 128 holds the second X-axis timing belt 126 to fix at a given position of the second X-axis timing belt 126. Accordingly, as the second X-axis timing belt 126 rotates between the first tool moving pulley 125 and the second tool moving pulley 127, the tool moving member 128 also moves according to the direction of rotation of the second X-axis timing belt 126. The tool moving guide shaft 129 is inserted through the tool moving member 128. The tool moving guide shaft 129 is disposed extending in the X direction. Both end portions of the tool moving guide shaft 129 are fixed to a housing of the sheet processing apparatus 100. Therefore, along with rotation of the second X-axis timing belt 126, that is, along with rotation of the X-axis drive motor 121, the tool moving member 128 is guided by the tool moving guide shaft 129 to move in the X direction alone. In other words, the tool moving guide shaft 129 guides the tool moving member 128 of the tool moving device 120 in the X direction that is the intersecting direction, therefore also guides the processing tools 105 in the intersecting direction. Consequently, as the X-axis drive motor 121 rotates in the forward direction and the reverse direction, the tool holding device 110 that is coupled with and fixed to the tool moving member 128 reciprocally moves in the direction (the X-axis direction) intersecting the conveyance direction of the sheet 1. Accordingly, the processing tools 105 are held to be reciprocally movable in the direction (the X-axis direction) intersecting the conveyance direction of the sheet 1.

The tool moving guide shaft 129 that functions as a guide is inserted through the tool moving member 128. The tool moving guide shaft 129 is disposed extending in the X direction. Both end portions of the tool moving guide shaft 129 are fixed to a housing of the sheet processing apparatus 100. Therefore, along with rotation of the second X-axis timing belt 126, that is, along with rotation of the X-axis drive motor 121 that is a single drive source, the tool moving member 128 is guided by the tool moving guide shaft 129 to move in the X direction alone. In other words, the tool moving device 120 includes the moving guide shaft 129 to guide the tool moving device 120 in the intersecting device of the plurality of processing tools. Consequently, as the X-axis drive motor 121 rotates in the forward direction and the reverse direction, the tool holding device 110 that is coupled with and fixed to the tool moving member 128 reciprocally moves in the intersecting direction (the X-axis direction) intersecting the conveyance direction of the sheet 1. Accordingly, the moving guide shaft 129 guides the processing tools 105 (i.e., the cutter tool and the creasing tool 112) in the intersecting direction that is the X direction.

Next, a detailed description is given of the configuration of the tool holding device 110.

FIG. 7 is an enlarged perspective view illustrating a part of the tool holding device 110 and the tool moving device 120 of the sheet processing apparatus 100.

As illustrated in FIG. 7, the cutter tool 111 and the creasing tool 112 are disposed in the Y direction without overlapping with the X direction and are aligned (arranged) parallel to a straight line extending in the Y direction that is the conveyance direction of the sheet 1. In other words, the plurality of processing tools 105 (i.e., the cutter tool 111 and the creasing tool 112) are linearly disposed (arranged) in the Y direction.

Further, the cutter tool 111 and the creasing tool 112 are retained by the tool retaining member 117 as a single component or together in the X direction (an intersecting direction that intersects the conveyance direction of the sheet 1). The tool moving member 128 is fixed on top of the tool retaining member 117. As described above, since the tool moving guide shaft 129 is inserted through the tool moving member 128, the tool retaining member 117 is movable in the X direction alone by the tool moving guide shaft 129. Accordingly, the cutter tool 111 and the creasing tool 112 together move in the X direction alone that is an orthogonal direction that is orthogonal to the conveyance direction of the sheet 1 (in other words, the intersecting direction that intersects the conveyance direction of the sheet 1) while maintaining the state in which the cutter tool 111 and the creasing tool 112 are aligned in a parallel direction that is parallel to the Y direction that is the conveyance direction of the sheet 1.

Note that, as described above, the tool moving member 128 holds the second X-axis timing belt 126, and therefore slides in the X direction by driving of the X-axis drive motor 121 that is a single drive source in the X direction. That is, the cutter tool 111 and the creasing tool 112 reciprocally move in the X direction alone while maintaining a linear disposition in the Y direction by a single drive source.

Further, the cutter tool 111 performs a contact and separation operation with respect to the sheet 1 by the first contact separation actuator 115, in other words, the first contact separation actuator 115 causes the cutter tool 111 to contact and separate with respect to the sheet 1. Similarly, the creasing tool 112 performs a contact and separation operation with respect to the sheet 1 by the second contact separation actuator 116, in other words, the second contact separation actuator 116 causes the creasing tool 112 to contact and separate with respect to the sheet 1. That is, the first contact separation actuator 115 and the second contact separation actuator 116 are controlled by the control device 300, which is described below. Accordingly, the first contact separation actuator 115 and the second contact separation actuator 116 operate the cutter tool 111 and the creasing tool 112 separately.

Consequently, the sheet processing apparatus 100 controls contact and separation with respect to the sheet 1 performed by the plurality of processing tools. As a result, the sheet processing apparatus 100 is capable of causing one of the plurality of processing tools 105 to contact the sheet 1 and another of the plurality of processing tools 105 to separate from the sheet 1. Further, the sheet processing apparatus 100 causes the tool moving device 120 to move the processing tools 105 relatively to the sheet 1 in the intersecting direction while in the state in which one of the processing tools (one processing tool) contacts the sheet 1 and another of the processing tools (a processing tool other than the processing tool in contact with the sheet 1) separates from the sheet 1. According to this relative movement of the processing tools, the cut process and the crease process are controlled separately, and therefore the sheet processing is performed to the sheet 1 with a given shape.

Configuration of Tool Facing Device 130.

Next, a description is given of the configuration of the tool facing device 130, with reference back to FIG. 3.

As illustrated in FIG. 3, the tool facing device 130 includes the first facing roller 131, the second facing roller 132, first gripping rollers 133 (that is, a first gripping roller 133a and a first gripping roller 133b), and second gripping rollers 134 (that is, a second gripping roller 134a and a second gripping roller 134b). Each of the first facing roller 131 and the second facing roller 132 functions as a tool facing portion. Each of the first gripping rollers 133 and the second gripping rollers 134 functions as a sheet gripper.

The first facing roller 131 and the second facing roller 132 are rotary members that are supported by respective rotary shafts to rotate about the respective rotary shafts in both directions, which are the forward direction and the reverse direction, by a drive source such as an electric motor. The first facing roller 131 and the second facing roller 132 rotate (move) to convey the sheet 1 in synchrony with conveyance of the sheet 1 by the first pair of conveyance rollers 151 and the second pair of conveyance rollers 152. The first facing roller 131 and the second facing roller 132 also function as tool facing members having tool facing portions (positions) disposed facing the processing tools 105. The first facing roller 131 and the second facing roller 132 are also drive rollers. The first facing roller 131 includes a first facing portion. Further, the second facing roller 132 includes a second facing portion.

The first gripping rollers 133 (that is, the first gripping roller 133a and the first gripping roller 133b) are driven rollers that function as rotary members and are supported by respective rotary shafts and disposed facing the first facing roller 131 that is a drive roller to the first gripping rollers 133. The first gripping rollers 133 (that is, the first gripping roller 133a and the first gripping roller 133b) are rotated about the respective rotary shafts along with rotation of the first facing roller 131. Similarly, the second gripping rollers 134 (that is, the second gripping roller 134a and the second gripping roller 134b) are driven rollers that function as rotary members and supported by respective rotary shafts and disposed facing the second facing roller 132 that is a drive roller to the second gripping rollers 134. The second gripping rollers 134 (that is, the second gripping roller 134a and the second gripping roller 134b) are rotated about the respective rotary shafts along with rotation of the second facing roller 132. The first gripping rollers 133 are disposed facing the first facing roller 131. The second gripping rollers 134 are disposed facing the second facing roller 132. The sheet 1 is gripped by the first facing roller 131 and the first gripping rollers 133 and by the second facing roller 132 and the second gripping rollers 134, so that the sheet 1 is reciprocally moved (conveyed) in the Y direction. That is, when the sheet processing is performed to the sheet 1, the sheet 1 is conveyed by the first facing roller 131 and the first gripping rollers 133 and by the second facing roller 132 and the second gripping rollers 134, in addition to, by the first pair of conveyance rollers 151 and by the second pair of conveyance rollers 152.

Each of the first gripping rollers 133 includes a first gripping member that is disposed facing the first facing roller 131 that functions as a first facing portion and that grips the sheet 1 together with the first facing roller 131. Similarly, each of the second gripping rollers 134 includes a second gripping member that is disposed facing the second facing roller 132 that functions as a second facing portion and that grips the sheet 1 together with the second facing roller 132.

Each of the first gripping rollers 133 is pressed (biased) by a biasing member in the −Z direction so as to be pressed against the first facing roller 131. Each of the second gripping rollers 134 is pressed (biased) by a biasing member in the −Z direction so as to be pressed against the second facing roller 132. Therefore, the first facing roller 131 and the first gripping rollers 133 (that is, the first gripping roller 133a and the first gripping roller 133b) grip the sheet 1 while the sheet 1 is being processed. Further, the second facing roller 132 and the second gripping rollers 134 (that is, the second gripping roller 134a and the second gripping roller 134b) also grip the sheet 1 while the sheet 1 is being processed. Note that, in FIG. 3, a part of the second gripping rollers 134 (that is, the second gripping roller 134b) is hidden behind the tool holding device 110, and therefore the second gripping roller 134b is not depicted in FIG. 3.

When processing the sheet 1, as the first facing roller 131 and the second facing roller 132, both of which function as drive rollers, rotate in the forward and reverse rotations, the sheet 1 in the processing is reciprocally moved (conveyed) in the Y direction. That is, the tool facing device 130 includes a conveying device that functions as a sheet conveyor that reciprocally moves (conveys) the sheet 1 in the Y direction. Due to the control of rotation of the tool facing device 130, the sheet 1 is reciprocally moved between the cutter tool 111 and the first facing roller 131 and between the creasing tool 112 and the second facing roller 132.

The first facing roller 131 that includes a tool opposing face to face the cutter tool 111 and the second facing roller 132 that includes the tool opposing face to face the creasing tool 112 are rollers including elastic bodies represented by silicon rubber and ethylene propylene (EP) rubber.

In the present embodiment, the pairs of conveyance rollers 150, various rotary members, and the X-axis drive motor 121 are based on stepping motors. However, as long as the above-described operations are performed, the type of a drive source is not limited. Further, the first contact separation actuator 115 and the second contact separation actuator 116 are based on respective solenoids. However, as long as the above-described operations are performed, the type of a drive source is not limited.

Detailed Description of Tool Facing Device 130.

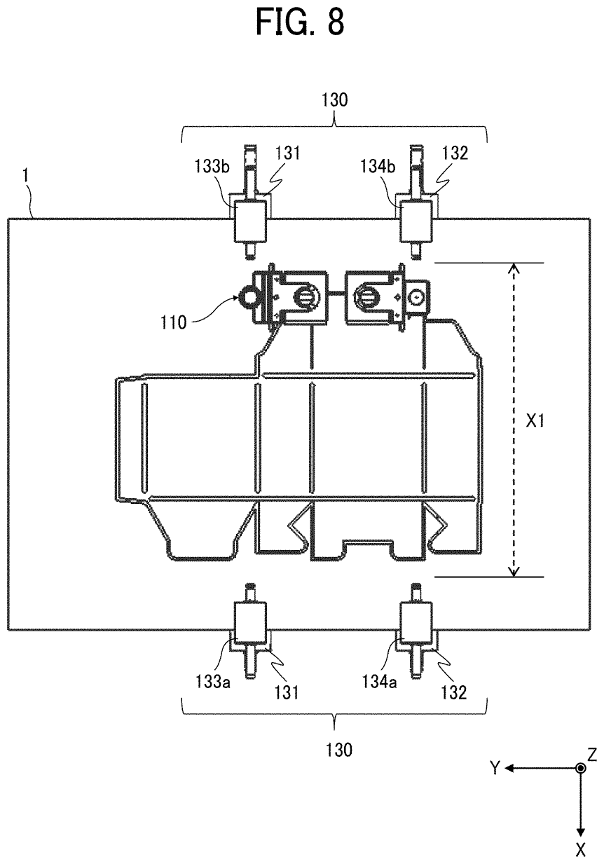

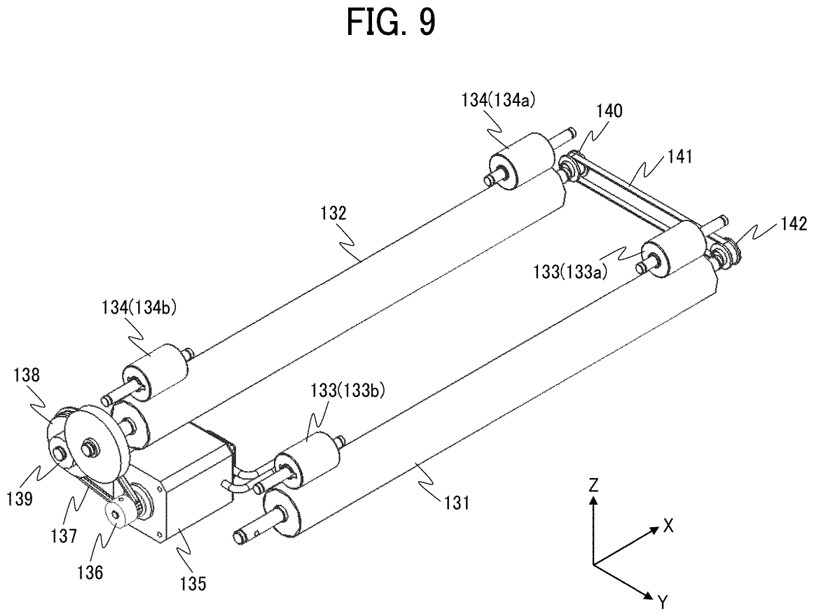

Next, a detailed description is given of the configuration of the tool facing device 130, with reference to FIGS. 8 and 9.

FIG. 8 is a plan view illustrating the tool facing device 130 and the tool holding device 110, viewed from the Z direction. FIG. 9 is a perspective view illustrating the configuration of the drive system of the tool facing device 130.

As illustrated in FIG. 8, the first gripping rollers 133 (i.e., the first gripping roller 133a and the first gripping roller 133b), which form pairs with the first facing roller 131 separately, are disposed on the downstream side in the conveyance direction of the sheet 1 (the Y direction) across the tool holding device 110. Further, the second gripping rollers 134 (that is, the second gripping roller 134a and the second gripping roller 134b), which form pairs with the second facing roller 132 separately, are disposed on the upstream side in the conveyance direction of the sheet 1 (the Y direction) across the tool holding device 110. Further, as illustrated in FIG. 2, the tool moving device 120 is also disposed so that a large portion of the tool moving device 120 faces the tool facing device 130 between the first facing roller 131 and the second facing roller 132.

A moving range X1 of the tool holding device 110 is indicated by a broken line with arrows in FIG. 8. The tool holding device 110 moves in the moving range X1 with respect to the width of the sheet 1. That is, the moving range X1 indicated by the broken line with arrows in FIG. 7 corresponds to an available process region of the sheet 1. Therefore, the first gripping rollers 133 and the second gripping rollers 134 are disposed out of the process region in which the processing tools 105 perform sheet processing to the sheet 1.

The first gripping rollers 133 and the second gripping rollers 134 are disposed on the extension lines of the cutter tool 111 and the creasing tool 112 in the directions of movement of the cutter tool 111 and the creasing tool 112. Accordingly, the grip positions at which the first facing roller 131 and the first gripping rollers 133 grip the sheet 1 are on the extension line of the cutter tool 111 in the X direction, where the cutter tool 111 performs the cut process to the sheet 1. Similarly, the grip positions at which the second facing roller 132 and the second gripping rollers 134 grip the sheet 1 are on the extension line of the creasing tool 112 in the X direction, where the creasing tool 112 performs the crease process to the sheet 1.

Further, the length of the first facing roller 131 and the length of the second facing roller 132 are longer than the width of the sheet 1 to be processed and the first gripping rollers 133 and the second gripping rollers 134 are disposed at respective positions where the first gripping rollers 133 and the second gripping rollers 134 grip respective end portions (edges) of the sheet 1. In other words, each of the first gripping rollers 133 and the second gripping rollers 134 grips the sheet 1 at a position closer to the corresponding edge of the sheet 1 than the position at which each of the first facing roller 131 and the length of the second facing roller 132 faces the corresponding processing tool 105. The grip range of the first facing roller 131 and the first gripping rollers 133 and the grip range of the second facing roller 132 and the second gripping rollers 134 include the inner side and the outer side of the side end portions of the sheet 1. In other words, the first facing roller 131, the second facing roller 132, the first gripping rollers 133, and the second gripping rollers 134 lie across the border of the side end portions of the sheet 1. That is, the tool facing device 130 grips the sheet 1 across each side end portion of the sheet 1. By gripping the sheet 1 as described above, the positional deviation of the sheet 1 in conveyance of the sheet 1 is restrained.

As described above, the sheet processing apparatus 100 according to the present embodiment grips the sheet 1 at the same positions as the process positions in the conveyance direction of the sheet 1 (that is, the positions where the first facing roller 131 and the second facing roller 132 are disposed). Further, the sheet processing apparatus 100 according to the present embodiment grips the sheet 1 across the side end portions (edges) of the sheet 1. According to this configuration, the sheet processing apparatus 100 according to the present embodiment maintains the position of the sheet 1 at the process positions reliably, and therefore “sag” and “deviation” of the sheet 1, which may cause to the sheet 1 when sheet processing is performed to the sheet 1, are prevented. Accordingly, the preferable processing accuracy is achieved.

As illustrated in FIG. 9, the tool facing device 130 is provided with a tool driving system having components including a Y-axis drive motor 135, a Y-axis output timing pulley 136, a first Y-axis timing belt 137, a Y-axis reduction timing pulley 138, an opposing elastic roller rotary pulley 139, a first Y-axis coupling drive pulley 140, a second Y-axis timing belt 141, and a second Y-axis coupling drive pulley 142.

The Y-axis drive motor 135 is a driving source of the drive system of the tool facing device 130. The Y-axis drive motor 135 is coupled with the Y-axis reduction timing pulley 138 from the Y-axis output timing pulley 136 via the first Y-axis timing belt 137.

The Y-axis reduction timing pulley 138 rotates the opposing elastic roller rotary pulley 139 via a gear portion that is molded as a single component with the Y-axis reduction timing pulley 138. The opposing elastic roller rotary pulley 139 is fixed to one end portion of the rotary shaft of the second facing roller 132.

The first Y-axis coupling drive pulley 140 is fixed to the opposite end portion of the rotary shaft of the second facing roller 132. Further, one end portion of the rotary shaft of the first facing roller 131 is rotatably supported by the housing of the sheet processing apparatus 100. The second Y-axis coupling drive pulley 142 is fixed to the opposite end portion of the rotary shaft of the first facing roller 131. The second Y-axis timing belt 141 is wound around the first Y-axis coupling drive pulley 140 and the second Y-axis coupling drive pulley 142.

As the Y-axis drive motor 135 drives, the one end portion of the rotary shaft of the second facing roller 132 rotates. Then, the first Y-axis coupling drive pulley 140 that is fixed to the opposite end portion of the second facing roller 132 rotates together with the second facing roller 132.

Consequently, the second Y-axis coupling drive pulley 142 that makes a pair with the first Y-axis coupling drive pulley 140 rotates since the second Y-axis coupling drive pulley 142 is coupled with the second Y-axis timing belt 141. Then, the first facing roller 131 is rotated along with rotation of the second Y-axis coupling drive pulley 142.

With this configuration, in the tool facing device 130, the second facing roller 132 and the first facing roller 131 rotates depending on whether the Y-axis drive motor 135 rotates in the forward direction or the reverse rotation. The second facing roller 132 and the first facing roller 131 separately face and contact the sheet 1 with pressure, so as to grip the sheet 1 when the sheet 1 is conveyed between the first facing roller 131 and the second facing roller 132. Therefore, the position at which the sheet 1 is conveyed and gripped by each second gripping roller 134 that is in contact with the second facing roller 132 corresponds to a “grip position.” Similarly, the position at which the sheet 1 is conveyed and gripped by each first gripping roller 133 that is in contact with the first facing roller 131 corresponds to a “grip position.”

The second gripping roller 134 is rotated along with rotation of the second facing roller 132. Similarly, the first gripping roller 133 is rotated along with rotation of the first facing roller 131. Then, the side end portions of the sheet 1 in the width direction of the sheet 1 are gripped by the second facing roller 132 and the second gripping rollers 134 and by the first facing roller 131 and the first gripping rollers 133. The sheet 1 is then reciprocally moved (conveyed) in the Y direction based on the rotational direction of the Y-axis drive motor 135.

Control Configuration of Sheet Processing Apparatus 100

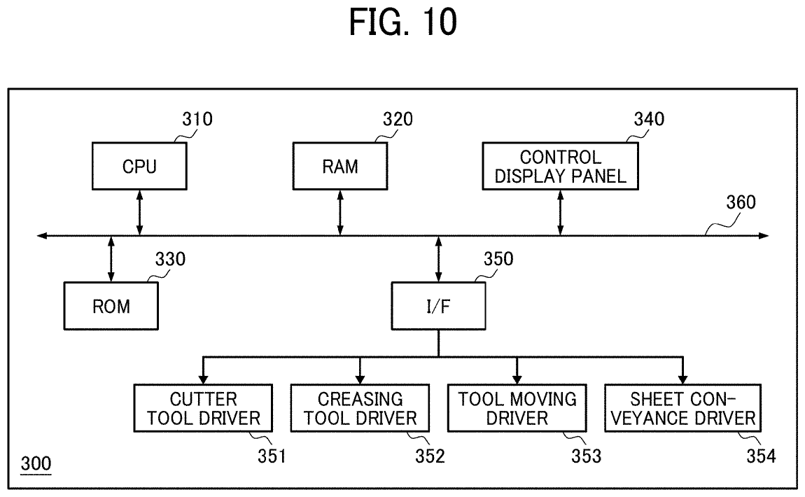

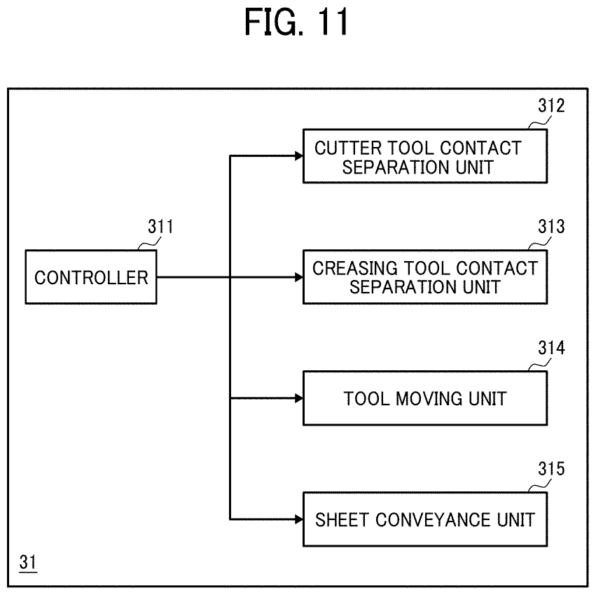

Next, a description is given of the control configuration of the control device 300 that is the control system of the sheet processing apparatus 100 according to the present embodiment of this disclosure, with reference to FIGS. 10 and 11.

FIG. 10 is a block diagram illustrating a hardware configuration of the control device 300 that is the control system of the sheet processing apparatus 100. FIG. 11 is a block diagram illustrating a functional configuration of the control device 300 that is the control system of the sheet processing apparatus 100.

As illustrated in FIG. 10, the sheet processing apparatus 100 includes the control device 300. The control device 300 has the same configuration as generally known information processing devices. That is, in the control device 300 according to the present embodiment of this disclosure, a central processing unit (CPU) 310, a random access memory (RAM) 320, a read only memory (ROM) 330, a control display panel 340, and an interface (I/F) 350 are connected via a bus 360. A cutter tool driver 351, a creasing tool driver 352, a tool moving driver 353, and a sheet conveyance driver 354 are connected to the I/F 350.

The CPU 310 is a calculation unit and controls the operation of the entire information processing device. The RAM 320 is a volatile memory capable of high-speed reading and writing of information. The RAM 320 is used as a work area when the CPU 310 processes information. The ROM 330 is a read-only non-volatile memory to store firmware, control programs, and the like. The control display panel 340 is provided with a display screen that displays information to notify a user of the operation status of the sheet processing apparatus 100, for example. The control display panel 340 also provides an input interface via which a user inputs a set value to be used for the control. For example, a user may operate the control display panel 340 to set the sheet size of the sheet 1.

The I/F 350 transmits a control signal generated as a result of calculation of the CPU 310, to a specified driver, so that the driver causes a corresponding unit to perform each designated function. The cutter tool driver 351 controls the contact and separation operations in which the cutter tool 111 selectively contacts to and separates from the sheet 1. The creasing tool driver 352 controls the contact and separation operations in which the creasing tool 112 selectively contacts to and separates from the sheet 1. The tool moving driver 353 controls rotational movement of the X-axis drive motor 121 in the forward and reverse directions. The sheet conveyance driver 354 controls respective rotational operations of the first facing roller 131 and the second facing roller 132 and rotational operations of the pairs of conveyance rollers 150.

Functional Configuration of Sheet Processing Apparatus 100.

In the hardware configuration described above, the CPU 310 performs calculation according to the program stored in the ROM 330, thereby constructing a software controller. A combination of the software controller thus constructed and the hardware constructs functional blocks that implement functions of the sheet processing apparatus 100 according to the present embodiment is formed.

As illustrated in FIG. 11, a control unit 31 is achieved by the control device 300 of the sheet processing apparatus 100 and includes a controller 311 that controls the whole operations of the sheet processing apparatus 100, a cutter tool contact separation unit 312, a creasing tool contact separation unit 313, a tool moving unit 314, and a sheet conveyance unit 315.

The cutter tool contact separation unit 312 causes the cutter tool 111 to contact, press, or separate from the sheet 1 at a given timing. The creasing tool contact separation unit 313 causes the creasing tool 112 to contact, press, or separate from the sheet 1 at a given timing.

The tool moving unit 314 controls the tool holding device 110 along the X-axis (the X direction), specifically, the moving direction, the moving amount, the moving speed, and timings of start and stop of movements of the tool holding device 110 along the X-axis (the X direction).

The sheet conveyance unit 315 controls the sheet 1 along the Y-axis (the Y direction), specifically, the moving direction (the conveyance direction), the moving amount, the moving speed, and timings of start and stop of movements of the sheet 1 along the Y-axis (the Y direction).

Note that, in the sheet processing apparatus 100 according to the present embodiment, the end portions in the width direction of the sheet 1 are gripped separately at the same positions as the positions in the conveyance direction of the plurality of processing tools 105 (i.e., the cutter tool 111 and the creasing tool 112). Accordingly, when each processing tool 105 performs the sheet processing to the sheet 1, the position of the sheet 1 is more stabilized.

The control unit 31 including a control program executed by the CPU 310 configures the above-described function units, so that the function units execute the control operations. By performing these control operations, the cutter tool 111 and the creasing tool 112 are moved while conveying the sheet 1, so as to selectively perform the contact and separation operations. By performing the contact and separation operations, while a given trajectory in the two-dimensional area is drawn on the sheet 1, the crease process is performed to the sheet 1 at a desired position or positions and the cut process is performed to cut the sheet 1 to a desired shape.

Embodiment of Image Forming System.

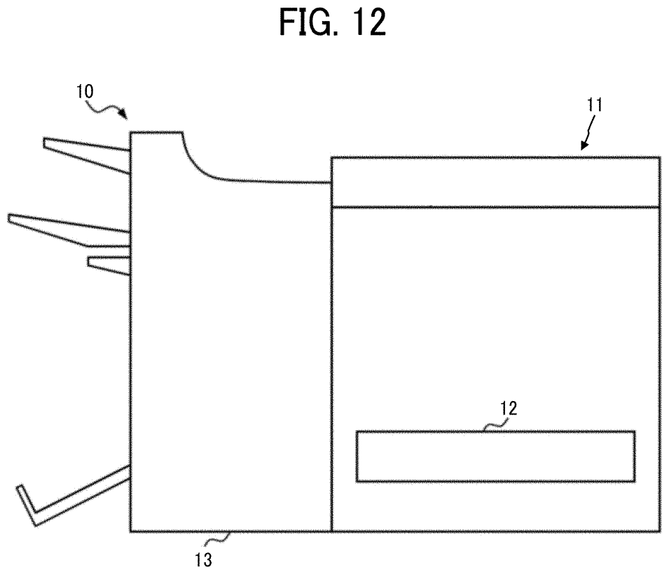

Next, a description is given of an image forming system according to an embodiment of this disclosure, with reference to FIG. 12.

FIG. 12 is a side view illustrating the external appearance of an image forming system 10 according to an embodiment of this disclosure.

The sheet processing apparatus 100 described above is applicable as a stand-alone apparatus but may be included in the image forming system 10.

The image forming system 10 includes an image forming apparatus 11 and a post-processing device 13. The image forming apparatus 11 includes a media feeding device 12. The image forming apparatus 11 forms a given image on a sheet 1 fed from the media feeding device 12 and conveys the sheet 1 toward the post-processing device 13. Note that the image forming apparatus 11 is an apparatus that attaches material (such as liquid ink and toner) to form an image onto the sheet 1 that functions as a recording medium and that relates to, for example, electrophotographic printing, inkjet printing, and screen printing.

In a case in which the sheet processing apparatus 100 is provided in the post-processing device 13, after the image forming apparatus 11 forms an image on the sheet 1, the sheet processing apparatus 100 performs the first processing and the second processing, as described above, to convey the processed sheet 1.

Effects of the Sheet Processing Apparatus of the Present Embodiment.

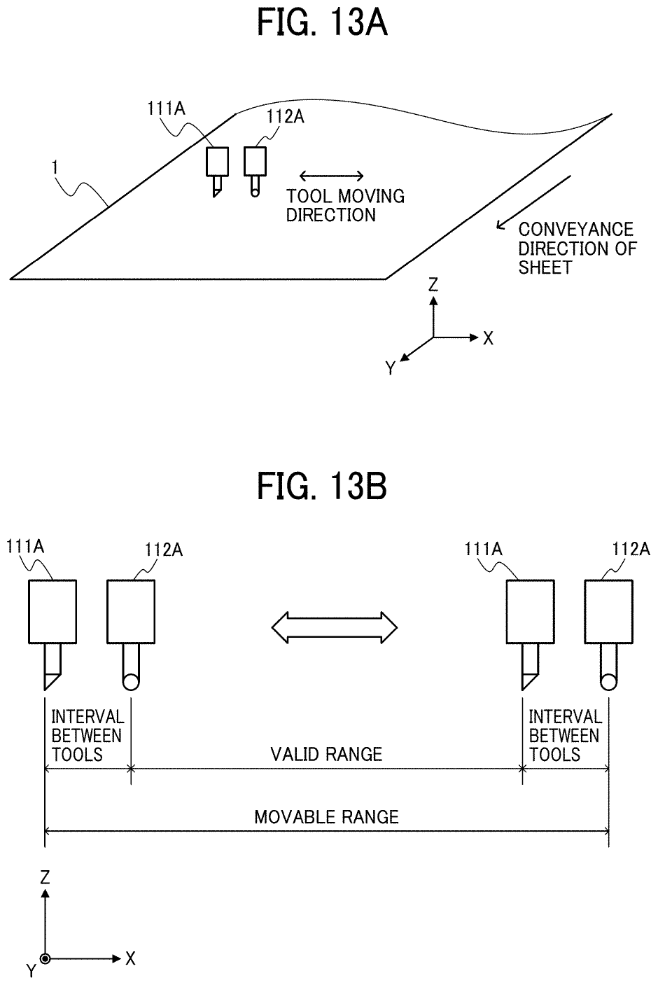

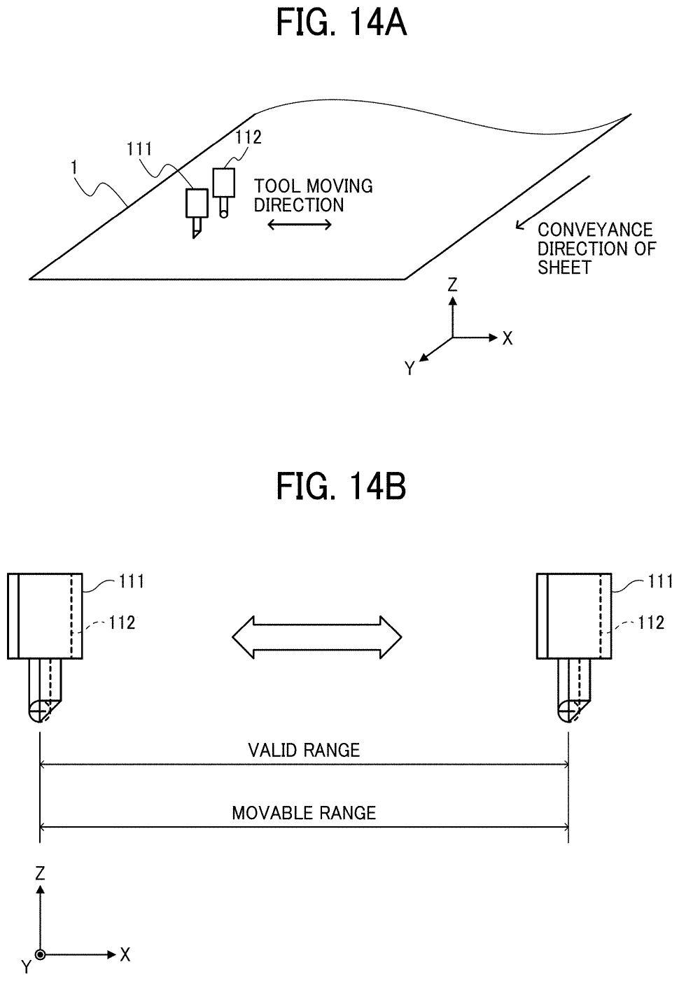

Now, a description is given of the effects of the sheet processing apparatus 100 according to the present embodiment in comparison with a known sheet processing apparatus, with reference to FIGS. 13A, 13B, 14A, and 14B.

A known sheet processing apparatus includes processing tools, which are a cutter tool and a creasing tool, disposed in a tool moving direction in which the cutter tool and the creasing tool move. The tool moving direction corresponds to a direction intersecting the conveyance direction of the sheet.

The known sheet processing apparatus has a configuration in which a plurality of processing tools is disposed along the tool moving direction. With this configuration, in the width direction of the sheet (i.e., the direction intersecting the conveyance direction of the sheet), a range within which sheet processing is performed to the sheet (in other words, a process available range) is reduced (becomes narrower) depending on the width of alignment (arrangement) of the plurality of processing tools. If the moving range of the processing tools in the width direction of the sheet is relatively large, the process available width of the sheet is increased. Therefore, when employing the technique used in the known sheet processing apparatus, the moving range of the processing tools is increased by the width of alignment of the processing tools. Accordingly, a sheet processing apparatus using the technique of the known sheet processing apparatus may cause a problem that an increase in the moving range of the processing tools leads to an increase in the width of the sheet processing apparatus by the same amount of the increase of the moving range of the processing tools.

FIGS. 13A and 13B are diagrams illustrating a configuration of a known sheet processing apparatus. FIGS. 14A and 14B are diagrams illustrating an effect of the configuration of the sheet processing apparatus 100 according to the present embodiment in comparison with the known sheet processing apparatus.

As illustrated in FIG. 13A, a cutter tool 111A and a creasing tool 112A are disposed in a parallel direction (the X direction) orthogonal to the conveyance direction of the sheet 1 (the Y direction). According to this alignment, as illustrated in FIG. 13B, a valid range (a process available range) in which the cutter tool 111A and the creasing tool 112A perform sheet processing to the sheet 1 is obtained by subtracting the width of alignment of the processing tools (i.e., the cutter tool 111A and the creasing tool 112A), in other words, the interval between the tools from each end (both ends) of the movable range, from the movable range (the maximum movable width) of the processing tools. Accordingly, in the known sheet processing apparatus, the available width of the sheet 1 that may be processed is limited due to the interval between the processing tools from each end (both ends) of the movable range of the processing tools and is restricted in a range within the movable range of the processing tools.

By contrast, the cutter tool 111 and the creasing tool 112 in the sheet processing apparatus 100 according to the present embodiment are aligned (arranged) in the parallel direction that is parallel to the conveyance direction of the sheet 1 (the Y direction), as illustrated in FIG. 14A. In other words, the cutter tool 111 and the creasing tool 112 are aligned in a direction orthogonal to the moving direction of the creasing tool 112 and the creasing tool 112. According to this alignment, as illustrated in FIG. 14B, the valid range (the process available range) in which the cutter tool 111 and the creasing tool 112 perform sheet processing to the sheet 1 is substantially equal to the movable range of the movable range (the maximum movable width) of the processing tools.

As described above, if the known sheet processing apparatus has the same maximum available width of the sheet 1 that may be processed, as the maximum available width of the sheet 1 of the sheet processing apparatus 100, the know sheet processing apparatus may increase in size in order to extend the valid range of movement of the processing tools. In other words, in a case in which the sheet processing apparatus 100 shares the same maximum available width of the sheet 1 to be processed with the known sheet processing apparatus, the sheet processing apparatus 100 achieves a reduction in size of the apparatus, that is, the sheet processing apparatus 100 has the size smaller than the known sheet processing apparatus. Further, if the sheet processing apparatus 100 shares the same apparatus size with the known sheet processing apparatus, the sheet processing apparatus 100 performs sheet processing to the sheet 1 larger in size than the sheet 1 handled by the known sheet processing apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure, and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet processing apparatus comprising:
a sheet conveyor configured to convey a sheet;
a plurality of processing tools disposed in a conveyance direction of the sheet, the plurality of processing tools configured to perform processing to the sheet; and
a tool moving device configured to move the plurality of processing tools in an intersecting direction intersecting the conveyance direction of the sheet.

2. The sheet processing apparatus according to claim 1,
wherein the plurality of processing tools is arranged in a direction parallel to the conveyance direction of the sheet.

3. The sheet processing apparatus according to claim 1,
wherein the tool moving device is configured to move the plurality of processing tools together in the intersecting direction.

4. The sheet processing apparatus according to claim 3,
wherein the tool moving device is configured to move the plurality of processing tools in the intersecting direction while in a state in which one of the plurality of processing tools contacts the sheet and another of the plurality of processing tools separates from the sheet.

5. The sheet processing apparatus according to claim 1,
wherein the tool moving device includes a guide configured to guide the plurality of processing tools in the intersecting direction.

6. The sheet processing apparatus according to claim 1,
wherein the tool moving device includes a single drive configured to move the plurality of processing tools in the intersecting direction.

7. The sheet processing apparatus according to claim 1, further comprising a tool contact separator configured to contact and separate the plurality of processing tools with respect to the sheet.

8. An image forming system comprising:
an image forming apparatus configured to form an image on a sheet and eject the sheet with the image; and
the sheet processing apparatus according to claim 1, configured to process the sheet with the image formed by the image forming apparatus.
